(19) United States
(12) Patent Application Publication
(10) Pub. No.: US 2009/0132113 A1
(43) Pub. Date: May 21, 2009

(54) SYSTEM AND METHOD FOR MANAGING MOBILE ASSET

(75) Inventors: Ajith Kuttannair Kumar, Erie, PA (US); Wolfgang Daum, Erie, PA (US); Steven Matthew Pelkowski, Erie, PA (US); Bradley Charles Hendrickson, Erie, PA (US); Mark Bradshaw Kraeling, Melbourne, FL (US); David Michael Peltz, Melbourne, FL (US); Glen Paul Peltonen, Palm Bay, FL (US); Gerald James Hess, Erie, PA (US); James Michael Kiss, JR., Melbourne, FL (US); Glenn Robert Shaffer, Erie, PA (US); Daniel Malachi Ballesty, Wattsburg, PA (US); Jeffrey James Kisak, Erie, PA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/345,135

(22) Filed: Dec. 29, 2008

Related U.S. Application Data
(63) Continuation-in-part of application No. 11/136,769, filed on May 25, 2005, now Pat. No. 7,500,436.
Application No. 11/136,769 is a continuation-in-part of application No. 10/850,992, filed on May 21, 2004.
(60) Provisional application No. 60/590,853, filed on Jul. 23, 2004.
(60) Provisional application No. 60/474,151, filed on May 22, 2003.

(51) Int. Cl. G06F 19/00

(52) U.S. Cl. 701/35; 701/1

(57) ABSTRACT

A system includes a location determination unit for determining a geographic location of a mobile asset having an engine that produces one or more emissions during use; a memory for storing a plurality of predetermined characteristic profiles, the characteristic profiles including information regarding geographic location and at least one of engine emission levels, noise emission levels, fuel usage levels, power output, load manifest, or speed level; a processor in communication with the memory for accessing the characteristic profile for the determined location of the mobile asset and generating a control command responsive to a selected characteristic profile; and a control unit on board the mobile asset controlling an operation of the mobile asset responsive to the control command. Associated methods are provided.

### RELATED APPLICATIONS

This application is a continuation-in-part of co-pending U.S. patent application Ser. No. 11/136,769 filed on 25 May 2005, which claims priority to U.S. provisional patent application 60/590,853, filed on 23 Jul. 2004; this application is also a continuation-in-part of co-pending U.S. patent application Ser. No. 10/850,992 filed on 21 May 2004 which claims priority to U.S. provisional patent application 60/474,151, filed on 22 May 2003. Each of these applications is incorporated herein by reference.

### TECHNICAL FIELD

This invention includes embodiments that relate to a control system for mobile asset operation. This invention includes embodiments that relate to a control method for mobile asset operation.

### DISCUSSION OF ART

Control system for assets that are mobile need be located with or on the asset, or may be located remote from the asset if there is communication infrastructure provided for interaction.

It may be desirable to have a control system for mobile asset operation that differs from those systems that are currently available.

### BRIEF DESCRIPTION

In one embodiment, a system includes a location determination unit for determining a geographic location of a mobile asset having an engine that produces one or more emissions during use; a memory for storing a plurality of predetermined characteristic profiles, the characteristic profiles including information regarding geographic location and at least one of engine emission levels, noise emission levels, fuel usage levels, power output, load manifest, or speed level; a processor in communication with the memory for accessing the characteristic profile for the determined location of the mobile asset and generating a control command responsive to a selected characteristic profile; and a control unit on board the mobile asset controlling an operation of the mobile asset responsive to the control command.

In one embodiment, a method of monitoring a mobile asset includes determining a location of a mobile asset; selecting a characteristic profile of the mobile asset as a function of the mobile asset location; controlling an operation of the mobile asset in response to a selected characteristic profile; monitoring values of the mobile asset operation during the operation control with reference to the selected characteristic profile; and storing the monitored values.

In one embodiment, a method for managing operation of a mobile asset that moves between at least two operating areas is provided. The mobile asset has at least two emission profiles of operation and travels along a path that intersects at least two operating areas. Each operating area has at least one emission profile associated therewith, with the emission profile of one operating area being different from that of a second area. The method includes monitoring a location of the mobile asset to determine its operating area; controlling an operation of the mobile asset as a function of the determined operation area and an associated emission profile, the emissions profile including a restriction on an operation of the mobile asset based on its position relative to an emission control area; and storing values of an emission parameter of the mobile asset associated with operation of the mobile asset in the operating area.

### BRIEF DESCRIPTION OF THE DRAWINGS

FIG. 1 is a block diagram of a control system of a mobile asset including a configuration input.

FIG. 2 is a table illustrating the relationship between control system inputs and outputs for two exemplary configuration modes of the mobile asset of FIG. 1.

FIG. 3 is a block diagram of a mobile asset control system in accordance with one aspect of the invention.

### DETAILED DESCRIPTION

This invention includes embodiments that relate to a control system for mobile asset operation. This invention includes embodiments that relate to a control method for mobile asset operation.

The terms “configuration” and “profiles” are used herein to describe the overall operating parameters and conditions of a mobile asset. These characteristics and profiles may alter the manner in which the operating systems of the mobile asset can be controlled in response to operational inputs. The mobile asset can be a vehicle or other engine powered assembly. Suitable vehicles include passenger and non-passenger vehicles, hybrid vehicles, off-highway vehicles, on-road vehicles (such as tractor trailers), tracked vehicles, air-borne vehicles, rail vehicles, and marine vessels. A mobile asset's configuration may include performance variables such as the peak output rating of the mobile asset engine, the correlation between the power level settings and the percentage of full power generated, engine emissions curves, acoustic emissions, electro-magnetic emissions, the number of traction motors used, fuel economy performance, adhesion limits, the organization, presentation and functionality of operator controls, communications protocol, auxiliary functions, security measures, and the like. External factors that can affect the mobile asset's desired configuration can include tax liabilities for operation, weather considerations, damage risk (due to crime or conflict), proximity to population centers, and the like.

FIG. 1 is a block diagram of a control system 10 of a mobile asset that can be operated in one of several configurations to match the mobile asset to a particular mission. The operating systems of a mobile asset include a plurality of end use devices 12, 14, 16, 18, 20. The end use devices may include fuel pumps, valves, lamps, semiconductor devices, switches, motors, compressors, resistance grids, shutters, ventilators, and energy storage batteries for a hybrid vehicle. These end use devices are part of respective operating systems of the mobile asset, such as the fuel system, engine-cooling system, braking system, diagnostic systems, operator control panels, internal environment, and like systems.

The end use devices may include elements located off-board the mobile asset, such as an off-board planning or reporting element, for example. A computing device such as a processor 22, executing operating instructions stored in a memory 24, is used to control the end use devices via end use device control signals 13, 15, 17, 19, 21. A plurality of operational input devices 26, 28, 30, 32 are in communication with the processor to provide a respective plurality of input signals 27, 29, 31, 33 to the processor. The input devices may be sensors, systems or other components located primarily on-board the mobile asset, and in some embodiments, off-board of the mobile asset. The stored instructions are programmed so that the end use devices are controlled in a predetermined manner in response to the operational inputs. Thus, the instructions executed by processor operate as a transfer function to convert a set of input signals 27, 29, 31, 33 to a set of output signals 13, 15, 17, 19, 21.

The mobile asset of FIG. 1 includes a configuration input device 34 different from the operational input devices (26, 28, 30, 32) connected to the processor for generating a configuration input signal 35, with the configuration input signal 35 having at least two state sets and being different from the input signals (27, 29, 31, 33). The computing device of FIG. 1 includes executable instructions that allow the relationship between at least one of the possible sets of operational input states (i.e., one set of values of 27, 29, 31, 33) and the respective mode of control of the end use devices (i.e., the set of values of 13, 15, 17, 19, 21) to be varied in response to the value of the configuration input signal. In other words, the processor may operate as two or more different transfer functions, with the selection of the transfer function being responsive to the configuration input signal. Thus, a mobile asset with two or more distinct configurations may be provided, such as two or more different exhaust emissions profiles, noise emission profiles, fuel usage profiles, and the like.

Note that FIG. 1 illustrates the configuration input device 34 as being on-board the mobile asset; however the dotted lines are meant to illustrate an embodiment where the configuration input device 34 may be located off-board of the mobile asset, with the configuration input signal 35 being provided to the mobile asset via a suitable communication link. Suitable communication links may include wireless communications mediums, and may include cellular communications, satellite communications, optical communications, or a combination of two or more of the foregoing (with switching apparatus as needed).

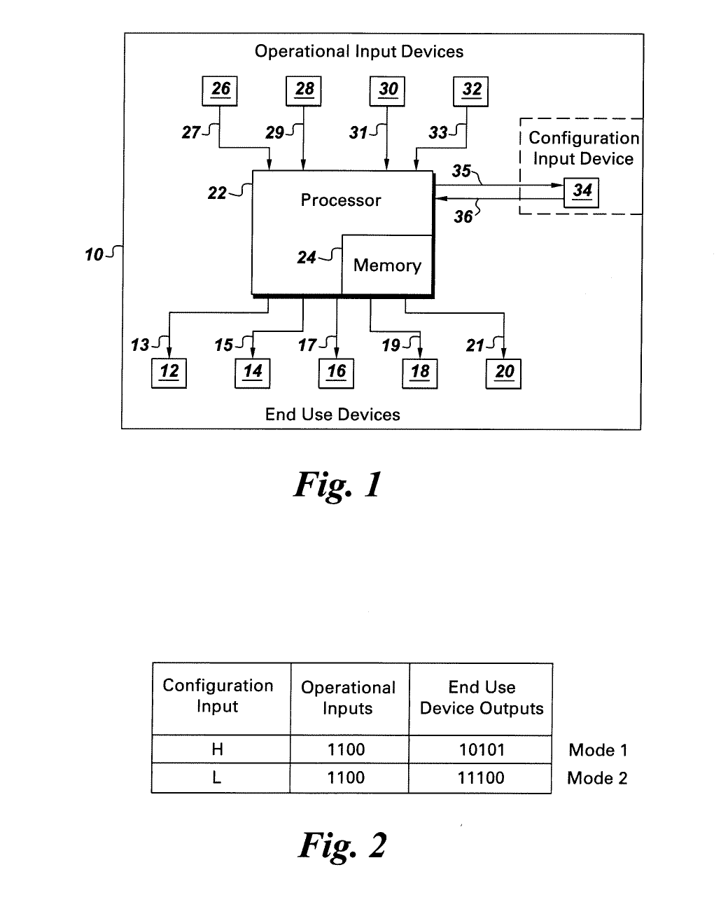

This concept is illustrated in the table of FIG. 2, where two different modes of operation are illustrated for two different configuration input state sets. When the configuration input has a high value H and the four operational inputs 27, 29, 31, 33 have values of (1, 1, 0 and 0) respectively, the processor will implement a first transfer function to produce output signals (13, 15, 17, 19, 21) having respective values of (1, 0, 1, 0, and 1) to control the five end use devices. This relationship is in accordance with a first configuration of the mobile asset, such as when operating under a first emissions limit. In contrast, when the configuration input has a low value L and the four operational inputs 27, 29, 31, 33 have those same values of (1, 1, 0 and 0) respectively, the processor will implement a second, different transfer function to produce output signals (13, 15, 17, 19, 21) having respective values of (1, 1, 1, 0 and 0), thereby controlling the five end use devices differently than in the first mode. This relationship is in accordance with a second configuration of the mobile asset, such as when operating under a first emissions limit, different than the first configuration.

A difference in the control signals provided to the end use devices 12, 14, 16, 18, 20 between these two modes allows the mobile asset to be configured in two different ways in response to the configuration input variable. The control system and variable states used in the illustration of FIGS. 1 and 2 are illustrative only. These mobile asset embodiments may literally include hundreds of such inputs and outputs, including more than one configuration input variable, and including analog, digital, neural network, or fuzzy logic circuitry. Portions of the processing may be accomplished off-board of the mobile asset and communicated to an on-board device for further processing or direct end use device control. Furthermore, the processor may provide an input signal 36 to the confirmation input device, such as feedback from a learning function used to modify an input behavior. In one embodiment, a time series infinite polynomial Taylor function may be used to modify a sensor function. A learning function implemented by processor may further learn in a first manner in one configuration and in a second manner in a second configuration. A distributed learning function may be accomplished on-board the mobile asset in real time in order to provide improved performance over prior art devices.

By way of example, a fuzzy logic controller (FLC) may be a knowledge-based system in which the knowledge of mobile asset operators, mobile asset engineers or knowledge gained from a fleet of mobile assets has been used to synthesize a closed loop controller for the mobile asset. Such FLCs can derive from a knowledge acquisition process, but may be automatically synthesized from self-organizing control architecture. The mobile asset sensors used by an FLC may be less expensive and may require relatively less precision than the sensors used by a traditional non-fuzzy controller due to the distinct granularity level with which the control laws may be processed by the FLC. It will be further appreciated that fuzzy logic may be used in a mobile asset to make decisions and provide measurement and/or control outputs based on one or more inputs of an analog nature in accordance with a set of inferencing rules. Fuzzy logic can make “best guess” decisions in circumstances where input data is incomplete and/or inconsistent. It is contemplated that a FLC can enable the owner of a fleet of mobile assets to customize mobile asset operation for any given application. Mobile asset parameters may be stored in a suitable memory, and control functions may be performed in control logic. Thus, the owner may readily update the information on a computer and download updated mobile asset parameters to individual mobile assets. A portable receiver/transmitter may be utilized to transfer information to the mobile asset controller by way of a communications link.

It is further contemplated that one may use a reconfigurable fuzzy logic controller which may be general purpose, yet have a functionality that may be readily adjusted in accordance with the type of mobile asset and/or mobile asset application. For example, the core structure of the fuzzy logic controller may be virtually identical for a myriad of mobile asset applications. However, application-specific definitions of both fuzzy logic membership functions and/or fuzzy logic rules may be input to the controller as a set of parameters, such that the fuzzy logic controller is programmably reconfigurable without changing the actual fuzzy logic. In one exemplary embodiment, a configurable mobile asset embodying aspects of the invention may include a fuzzy logic processor configured to generate one or more transfer functions or executable instructions for relating the input signals to the output control commands during a given configuration mode.

By way of example, a neural network controller may comprise at least one neural network estimator for generating one or more estimated transfer functions. The neural network estimator may be coupled to receive selected sensed mobile asset operating parameters from various sensors, such as speed, emissions, power level, tractive effort, and the like, to generate an estimated transfer function that may be coupled to an actuator system. In another example, the neural network estimator can be coupled to receive inputs from processors generating computed values of mobile asset operating parameters (e.g., from other neural networks, fuzzy logic controller, or mobile asset models programmed in a processor of the controller) in addition to sensed parameters.

The neural network estimator may be a nonlinear estimator that can be trained to map a selected range of input signals so as to generate a desired output parameter that varies in correspondence with the input signals. The neural network estimator may include an input neuron layer and at least a first hidden neuron layer. Multiple hidden neuron layers, e.g., through an nth hidden neuron layer, may be coupled together, with the nth hidden neuron layer being coupled to an output neuron layer. By way of example, biasing means (such as a power supply that provides a stable, determinable power level or any other suitable biasing device) may be coupled to each neuron layer of the neural network estimator to provide a means to adjust the transfer function of the controller, e.g., a squashing function, or the non-linear characteristic function for respective neurons in a layer. Signals passed from each layer to the next may be processed by applying respective weights (associated with each respective neuron) to each signal passing from the neuron. The respective weights for each layer may be determined in a training sequence using techniques readily understood by one skilled in the art. For example, during training of a neural net, prescribed patterns of input signals may be sequentially and repetitively applied, for which patterns of input signals there may be corresponding prescribed patterns of output signals known.

The pattern of output signals generated by the neural net, responsive to each prescribed pattern of input signals, may be compared to the prescribed pattern of output signals to develop error signals, which are used to adjust the weights as the pattern of input signals is repeated several times, or until the error signals are detected as being negligibly valued. Then training may be done with the next set of patterns in the sequence. During extensive training the sequence of patterns may be recycled. In one exemplary embodiment, a configurable mobile asset embodying aspects of the invention may include a neural network processor configured to adjust, e.g., over a training period or sequence, one or more transfer functions or executable instructions for relating the input signals to the output control commands.

Optimal control techniques may be used to design a multivariable mobile asset controller, and an all-encompassing true “optimal” design may not be realistic since in a practical implementation achieving a partially optimal design should be considered a success. For example, it is contemplated that such a design will make coordinated use of all input, output and control variables, and will be organized to ensure a stable mobile asset controller that can be logically changed (e.g., reconfigured) to meet a set of desired performance objectives for the mobile asset. In one exemplary embodiment, optimal control techniques may be attractive since such techniques can readily handle multi-input systems and allow the designer to quickly determine appropriate candidate values for a control law matrix. All possible system states may not be available for performing a given control strategy. For example, it may be neither practical nor necessary to install a sensor for sensing every possible mobile asset state since one can provide an estimator for estimating any missing states rather than sensing or measuring every possible mobile asset state.

In one exemplary embodiment one may make use of optimal estimation techniques as a tool in the design of a multivariable mobile asset estimator that may be used in conjunction with the mobile asset controller. An optimal estimation technique may be a time-varying optimal estimation solution, referred to as the “Kalman filter”. Essentially, the optimal estate solution in this case is given by a recursive weighted least-square solution.

In one embodiment of the invention the configuration input signal 35 may be responsive to geographic location of the mobile asset. The location of the mobile asset may be determined using an appropriate input device 34, such as a global positioning system (GPS) or a wireless wayside automatic electronic identification (AEI) tag, for example. Alternatively, the configuration input signal 35 may be indicative of the health of the mobile asset, such as may be derived from on-board or off-board equipment, including diagnostic and/or control systems. Or, the configuration input may be responsive to an operator input, such as when the configuration input device 34 is an operator-controlled switch, computer mouse, touch screen, keyboard, identification card reader, bar code reader, etc., with or with the requirement for a password or key.

In addition to the operator being located on board the mobile asset, configuration of the mobile assets may be effected from a location adjacent to the mobile asset such as at a control tower, or remote from the mobile asset such as from a remote data center or dispatch office. In one embodiment, a signal indicative of the health of one mobile asset of a group may be used to reconfigure a second mobile asset in the group; for example, when a maximum power generating capacity of the first mobile asset becomes degraded, the second mobile asset may be reconfigured to a higher peak power level to make up for power lost from the first mobile asset. In another embodiment, a signal indicative of an emission limit may be received from a central emission control center and may be used to configure the vehicle to operate within that emission limit. The configuration input may alternatively include a device that changes an analog or digital signal; for example, altering, adding or deleting a message, changing a message sequence, or offsetting a sensor signal to cause the mobile asset to operate in a different configuration.

In another embodiment, the configuration input may be responsive to an operator input. For example, an operator of the mobile asset may implement a different configuration upon identifying that the mobile asset is entering a different area having different configuration requirements, such as by recognizing a milepost marker or other rail side indicia, indicative of a boundary of the different area. In another embodiment, configuration inputs for changing a configuration may be pre-programmed based on distance of the mobile asset from a different operation area. For example, an operator may input a distance from a present location of the mobile asset to a different operational area. Then, based on a sensed distance traveled, the mobile asset may automatically change its operating configuration upon traveling the distance to arrive at the different area.

A boundary may include a state line between two states requiring different emission profiles. As the mobile asset detects leaving one state and entering an adjacent state by passing, for example paired transponders in a certain direction, the mobile asset may be instructed to change an emissions parameter corresponding to the requirements of the state it has just entered. In another aspect of the invention, the reader may be mounted on a different mobile asset or rail car of a train of which the mobile asset is a member. For example, the mobile asset being controlled may be a member of group of vehicles, wherein the different mobile asset is also a member of the group. The different mobile asset detects its location and transmits the location information to the mobile asset for controlling the mobile asset's emissions responsive to the location information provided by the different mobile asset.

One or multiple aspects of the mobile asset's performance may be altered to change the mobile asset's configuration in response to a change in the configuration input. In one embodiment, the mobile asset may be reconfigured from a first horsepower rating to a second horsepower rating in response to a configuration input change. Consider an example where a taxing authority levies a tax that increases with the size/power rating of the mobile asset. A change in configuration may be accomplished in response to an operator selection as the configuration input variable, or alternatively it may be performed automatically in response to a configuration input responsive to location as the mobile asset approaches the geographic region of concern. The peak power level configuration change may involve instructions executed by the processor to change the response of end use devices in the throttle and/or fuel delivery systems of the mobile asset. The power output of the engine delivered in response to at least one of the power level setting is changed between the two configurations. This may be accomplished, for example, by including instructions executable by the computing device to recognize X power level settings in a throttle input device when the configuration input has a first value and to recognize more or less than X power level in the power level input device when the configuration input has the second value.

Another embodiment of the invention may change the number of traction motors that are powered in the mobile asset or the power level setting of the traction motors. In a first configuration, every traction motor on the mobile asset may be powered, such as would be needed for normal open road load hauling missions. In a second configuration, fewer than all of the traction motors may be powered. This may be accomplished using instructions executable by the computing device to permit the powering of X traction motors of the mobile asset when the configuration input has a first value and to permit the powering of less than X traction motors of the mobile asset when the configuration input has a second value. Similarly, the power level of the active traction motors may be varied in response to a configuration input variable.

The invention may be utilized in a mobile asset group where a plurality of mobile assets is joined together to function, for example, autonomously. All of the mobile assets in the group may be controlled by a single operator from a lead mobile asset, with the trailing mobile assets being in communication with the lead mobile asset and responding to the operator's input. In instances where applicable, each mobile asset may exhibits a maximum adhesion limit, i.e., an amount of power that can be applied to the wheel of the mobile asset before wheel slip will occur. If all of the mobile assets are not of the same type, have differing loads, differing wheel wear, or are on differing surfaces or grades, and therefore do not all have the same adhesion limit, situations can arise where uncontrolled wheel slip may occur if the lead mobile asset has a higher adhesion limit than a trailing mobile asset. One embodiment includes instructions executable by the computing device to operate an engine of a mobile asset below a first adhesion limit when the configuration input has the first value and to operate the engine of the mobile asset below a second adhesion limit less than the first adhesion limit when the configuration input has the second value. In this manner, a lead mobile asset having a higher adhesion limit than a trailing mobile asset may be reconfigured to operate as if it had the same adhesion limit as the trailing mobile asset, thereby eliminating problematic wheel slip concerns. The configuration input signal may be responsive to any operating parameter of another mobile asset in the train. For example, a signal indicative of the power level or of the health of a trailing mobile asset may be used as a configuration input signal for reconfiguring a lead mobile asset to a respective peak power level responsive to the signal.

The control systems of a mobile asset may be programmed to respond in accordance with a predetermined set of mission priorities. For example, the mission priority for an express road mobile asset may be to maintain the desired power output in order to ensure that a desired train speed is sustained so that an express delivery schedule can be satisfied. There may be situations where doing so may cause excessive wear, excessive emissions or other undesirable effects. For example, if one cylinder of the diesel engine becomes inoperative, the predetermined mission priorities will determine whether the mobile asset control system will provide additional fuel to the operating cylinders to compensate for the inoperative cylinder. Doing so may result in the engine exceeding an emission limit or may cause excessive wear on the engine. For a non-express service mobile asset, the mission priority may be to operate at all times within an emissions limit, or within a required fuel consumption limit, etc. For such non-express service, the mission priorities may simply allow the peak engine output to drop when one engine cylinder becomes inoperative. The invention may be utilized to allow a single mobile asset to be reconfigured from a first set of mission priorities to a second set of mission priorities in response to a change in value of a configuration input. Such a change may involve modifying many end use device output responses, including diagnostic and alarm systems. Such changes are impractical for prior art mobile assets, and thus mission priorities are sometimes compromised based upon the selection of an available mobile asset. The invention provides additional flexibility for a railroad dispatcher in matching available equipment with mission requirements.

In another embodiment, the configuration of an operator interface device may be changed in response to a configuration input variable. For example, different owners or operators may use various administrative and/or technology schemes, such as different emission profiles, different operator training profiles, usage profiles, tractive effort profiles, distributed power techniques, controlled tractive effort (CTE) profiles, radio communication frequencies, etc., that may be reflected in an operator interface device such as a touch screen input device. When attempting to operate a prior art mobile asset on more than one railroad, problems would be encountered if the mobile asset configuration were inconsistent with the mode of operation of the railroad. A simple example is the manner in which a railroad numbers the milepost markers along a rail line—some railroads use numbers and some railroads use letters. Another example is the manner in which a railroad configures its wireless radio communications between multiple mobile assets in a train consist. With the invention, a mobile asset may include appropriate hardware and software to function properly on a plurality of railroads, with the activation of the proper configuration for a particular railroad being responsive to a configuration input variable such as an operator's selection. The operator input may include the operator's identity, such as by keying an operator identification number into a keyboard, swiping an identification card through a card reader, etc. The operator identity may be used as a configuration input variable, for example automatically limiting the power level, geographic region of operation, or configuration of mobile asset interface devices in only those modes for which a particular operator has appropriate permissions.

As another embodiment of the invention, the computing device may control one or more operations of the mobile asset as a function of an emission profile, with the emission profile being made responsive to the configuration input value. An emission profile may be an operating profile that describes and defines the desired emissions performance of the mobile asset verses power output. For example, an emissions profile may include one or more emissions requirements, such as a maximum allowable value of an emission. An emission requirement may set a maximum value of an oxide of nitrogen (NOx) emission, a hydrocarbon emission (HC), a carbon monoxide (CO) emission, and/or a particulate matter (PM) emission. Other emission limits may include a maximum value of an electromagnetic emission, such as a limit on radio frequency (RF) power output, measured in watts, for respective frequencies emitted by the mobile asset. An emission requirement may be variable based on a time of day, a time of year, and/or atmospheric conditions such as weather or pollutant level in the atmosphere. It is known that emissions regulations may vary geographically across a railroad system. For instance, an operating area such as a city or state may have specified emissions objectives, and an adjacent operating area may have different emission objectives, for example a lower amount of allowed emissions or a higher fee charged for a given level of emissions. Accordingly, an emission profile for a certain geographic area may be tailored to include maximum emission values for each of the regulated emission including in the profile to meet a predetermined emission objectives required for that area.

The selection of a mobile asset for a mission is complicated if the route crosses multiple areas with differing emissions requirements. In other embodiments, the emission profile or emission objective/characteristic may be defined as a function of the time of day, weather, daily emission rating/classification, load weight, vehicle configuration, movement plan, road conditions, age or type of mobile asset, and/or business objective of the system operator. An emission parameter of an operating mobile asset may be compared to the emission profile for a particular area. A process executed by the computing device 22 is used to determine if an adjustment to one or more operating characteristics of the mobile asset is required. The emission profile may be associated with a gaseous, liquid, or solid byproduct of combustion, with an acoustic energy emission, a reflective emission, such as provided by a device for reflecting or absorbing electromagnetic energy, vibration emissions, and/or an electro-magnetic energy emission, such as radio, infrared, and visible light emissions. For example, if the monitored emission parameter is a chemical or gas output of the diesel engine and it is monitored as being higher than specified by the emission objective, the computing device may execute instructions to control engine/fuel system end use devices such as to change the engine timing or fuel delivery schedule or another control intended to reduce the emissions being generated by the engine. Other corrective actions may include shutting down the engine, adjusting mobile asset assignments within a group, adjusting one or more movement plans, changing engine cooling, changing engine load or tractive effort, changing the engine speed, utilizing hybrid energy for motoring, or storing hybrid energy in an energy storage system 148. Such action may be taken to achieve the emission characteristic for a particular mobile asset or may be taken on a system wide or sub-system basis in order to achieve an emission objective for a fleet of mobile assets and trains operated by a railway systems operator operating in one or more operating areas.

In one embodiment, the invention provides a method and apparatus for managing the emissions configuration of one or more mobile assets depending upon a configuration input variable, such as the location in which the mobile assets are located. For example, if a first operating area is an emission control area requiring a specified emission characteristic, the computing device manages the operation of the mobile asset (e.g., control outputs) in accordance with a first emission profile that will satisfy that objective when a location configuration input has a first value. When the configuration input changes value in response to movement of the mobile asset into a second operating area having a different emissions objective, the computing device controls the operation of the mobile asset in response to a different emission profile, i.e., at least one different output value for the same set of input values.

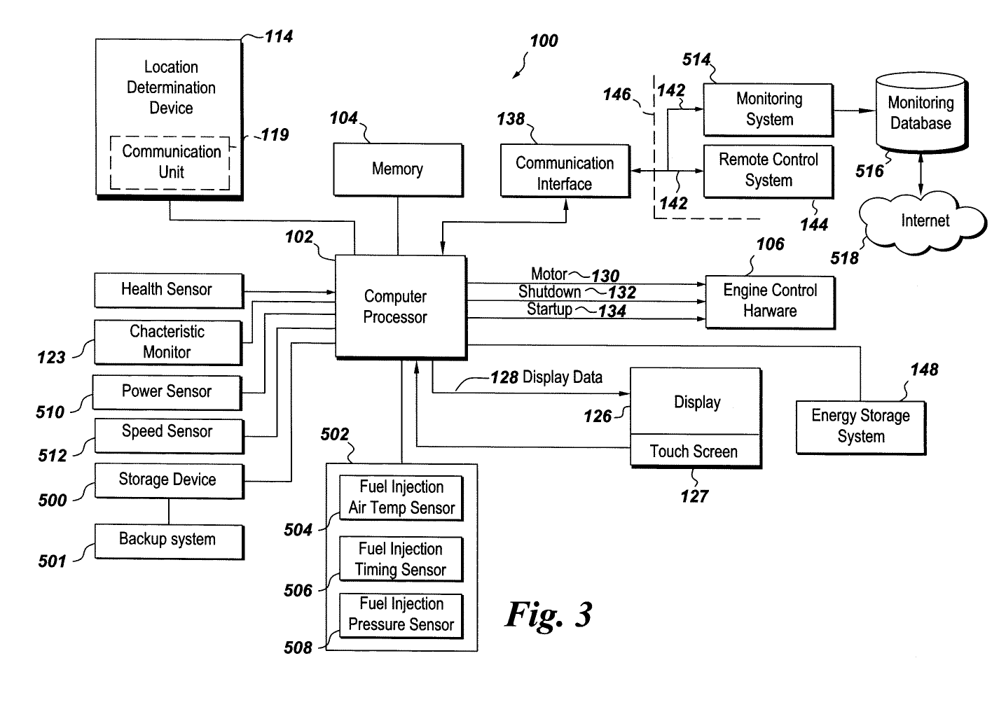

In an aspect of the invention illustrated in FIG. 3, a mobile asset control system 100 may include a computer processor 102 coupled to a memory 104 and to a location determination device 114. Engine control hardware 106, for those embodiments with an engine, can receive input from the processor (e.g., motor 130, shutdown 132 and startup 134). The location determination device includes a communication unit 119 (cellular, satellite, or both). A characteristic monitor 123 couples to the computer processor 102 as can a health sensor (shown but not numbered). A display 126, optionally with a touch screen 127, receives display data 128 from the processor.

A characteristic monitor 123 can, for example, monitor emissions exhausted by the mobile asset, such as electromagnetic interference, noise, and levels of oxides of nitrogen (NOx), carbon monoxide (CO), carbon dioxide (CO₂) and particulates. A communication interface 138 provides a conduit for the processor to communicate through a communication link 142 with an asset remote control system 144 at a remote center 146. The communication link may communicate also with a central monitoring system 514 (possibly co-located at the remote center). The central monitoring system can include a monitoring database 516, and which can provide updates and data via the internet 518.

The system may also include an operating parameter monitor 502 coupled to the computer processor, for monitoring mobile asset operating parameters indicative of an operation profile. The operating parameter monitor may include, for example, a fuel injection air temperature sensor 504, a fuel injection timing sensor 506, and a fuel injection pressure sensor 508 for monitoring these respective parameters. Such parameters may be used, for example, to calculate an emission level of a monitored engine. In another aspect, a horsepower, (or equivalent power measurement, such as megawatt-hours) produced by the mobile asset and a speed of the mobile asset may be monitored. For example, at certain times (such as every 0.1 hour) and/or at certain locations by power sensor 510 and speed sensor 512, respectively. As is known, such horsepower and speed information may be used to calculate an emissions profile of the mobile asset over the period that such information is recorded. The emission profile may be correlated to location information to show where the mobile asset was located when producing the emissions profile. Other parameters, such as fuel usage and engine exhaust characteristics may be monitored for example, by a fuel usage sensor and an engine exhaust characteristic sensor, respectively.

During operation, the mobile asset control system is in communication with a central monitoring system. The central monitoring system may be coupled to a central monitoring database, such as a central database used to monitor mobile asset parameters. The central monitoring database may be securely accessed, for example, via the Internet. The central monitoring system may receive emission information from one or more mobile assets over a secure communication link to track a characteristic (e.g., emissions, fuel use, temperature, speed) of one or more respective monitored mobile assets. An operational control system, which could be part of a remote control system 144, could provide feedback or control over the system. In an aspect of the invention, information provided by each mobile asset may be stored in the database 516 in addition to, or instead of, being stored locally on the storage device of the mobile asset. The information may be provided to the central monitoring system 514 as the information is acquired, or the information may be uploaded from the mobile asset on a periodic basis.

The system may provide an ability to operate a mobile asset within different emission profile configurations (such as within a Tier II NOx limit) while in different regions. The system may operate automatically with no operator input required to transition the mobile asset to a different emission profile configuration. The system may be programmed to limit interruption of the mobile asset performance while transitioning to a different emission profile configuration. The system may record and maintain a record of the date and time that a mobile asset enters and exits a pre-defined region, and/or a record of various system operating parameters, such as parameters indicative of emission generated by the engine, for example. The memory may record portions (e.g., as measured by clock time, fuel consumed, location, and the like) of the mobile asset operation in each available mode of operation, such as may be useful for subsequent tax reporting, billing or fleet management purposes.

In addition, no modification of engine control hardware is necessary. In the event of a malfunction of the configuration input device 34 (i.e., the location determination device), the system may instruct the mobile asset to revert to a default operation profile, alternatively, the operation profile of the last known configuration input may be used. Data may be redundantly stored or backed up and time stamped at periodic intervals using storage device 500 and backup system 501. These may also be used to store information to be batch uploaded to remote control system 144 if communications link 142 is unavailable at any given time, and may also serve as backup records for auditing of data at a later time. The configuration of the mobile asset may be changed in response to a configuration input signal that originates from the off-board central monitoring system, such as when the emission data for the fleet or for the particular mobile asset requires or allows a change in the emission profile for the mobile asset. Alternatively, the configuration of the mobile asset may be changed by operator input, such as via input to a touch screen device.

In an aspect of the invention, the stored emissions information for each mobile asset may be made available to a regulatory taxing agency, such as a taxing authority or environmental regulation authority, to verify emission compliance while the mobile asset, or a fleet of mobile assets, is operating in a certain area. Emission information may be provided for a mobile asset as it crosses a boundary of a predefined region, and/or provided for the period of time that the mobile asset operates within the region may be provided. For example, a state may require a certain emissions profile be maintained while a mobile asset is operating with in the boundaries of the state, and may require reporting of, for example, emission information for each mobile asset. The system allows such reporting to be provided and may be made available to a regulatory agency.

In another embodiment, emissions from a plurality of mobile vehicles of a fleet may be measured, and data responsive to the measured emissions communicated to a central database. The received data may then be processed relative to a fleet emission requirement. The received data may be used to generate an operating instruction for operating the fleet in compliance with the emission requirement. The operating instructions may then be communicated to at least one mobile vehicle of the fleet. In an embodiment, the operating instruction may include a command to adjust an emission output. In another embodiment, an actual emission of each of the mobile vehicles versus a corresponding emission requirement for each of the mobile vehicles may be measured to calculate a difference between the actual emission and the corresponding emission requirement. The differences may then be summing over the fleet to determine fleet compliance with the fleet emission requirement. A plurality of emission requirements may be in effect for a respective plurality of geographic areas over which the fleet operates. Accordingly, the data may be processed relative to a respective emission requirement in effect for a geographic area in which a respective vehicle is operating.

The emission information gathered may be used for planning purposes for operation within emission controlled regions that allow accumulation of emission “credits” for operating at emission levels below maximum allowed emission levels. For example, emission credits generated by operating below maximum allowed emissions may be accumulated and applied to offset penalties that may be assessed for other mobile assets operating above maximum allowed levels, so that overall fleet emissions in the region may be averaged to meet an emission requirement. For planning purposes, if a surfeit of credits has been built up, mobile assets may be scheduled to operate in more fuel efficient modes that may generate emissions exceeding a maximum allowed level until the accumulate credits are exhausted. In an embodiment, credits may be traded among different industrial participants operating in different areas, such as different States and in different countries. In another aspect, the emission information may be used to trade emission credits for the same mobile asset being operated within a geographical area having an associated emission requirement. For example, while descending a grade in the operational area, the mobile asset may be controlled to have an emission below a maximum allowed emission level for that area. During this time, emission credits may be accrued and these credits may be used to offset operations when an emission parameter is allowed to exceed a maximum value, such as when the mobile asset is climbing a grade. Consequently, an average emission of the mobile asset while in the area may be managed so that the average emission meets an emission requirement associated with the area.

A propulsion system controller (PSC) onboard each mobile asset may be responsive to control signals generated in response to commands wirelessly communicated with mobile asset communication equipment from a lead mobile asset relative to a remote group. By way of example, the group has a remote mobile asset and a trail mobile asset. Many group arrangements may be provided depending on the specific application. As will be described below, respective controllers on-board each mobile asset, such as distributed power controller (DPC), primary mobile asset controller (CAX), the PSC controller and the communication equipment may use appropriate control algorithms to selectively affect one or more operating characteristic for each mobile asset of a group upon receiving a configuration input signal.

The invention can use computer programming or engineering techniques including computer software, firmware, or hardware so that the technical effect is to provide a system for monitoring and controlling mobile asset engine emissions as described above. Any such resulting program, having computer-readable code means, may be embodied or provided within one or more computer-readable media, such as optical or magnetic memory, thereby making a computer program product, i.e., an article of manufacture, according to the invention. The computer readable media may be, for example, a fixed (hard) drive, diskette, optical disk, magnetic tape, semiconductor memory such as read-only memory (ROM), and the like, or through a transmitting/receiving medium such as the Internet, a cellular network, or a satellite transceiver.

The article of manufacture containing the computer code may be made or used by executing the code directly from one medium, by copying the code from one medium to another medium, or by transmitting the code over a network. The invention may include one or more processing systems such as a central processing unit (CPU), memory, storage devices, communication links and devices, servers, I/O devices, or any sub-components of one or more processing systems, including software, firmware, hardware or any combination or subset thereof, which embody the invention as set forth in the claims. User input may be received from a keyboard, mouse, pen, voice, touch screen, switch or any other means by which a human can input data, including through other programs such as application programs.

Various changes could be made in the above exemplary embodiments without departing from the scope of the invention. It is intended that the above description and accompanying drawings shall be interpreted as illustrative and not in a limiting sense. For example, the invention is described as embodied in a mobile asset, while similar systems and functions may be envisioned for any off-highway vehicle, marine vehicle, or stationary power generating unit that utilizes an electro-motive drive system similar to that of a mobile asset. In addition, the invention may be used for any mobile asset, such as cars, trucks, or busses, to manage the emissions of the mobile asset. It is further to be understood that the steps described herein are not to be construed as necessarily requiring their performance in the particular order discussed or illustrated. It is also to be understood that additional or alternative steps may be employed with the invention.

1. A system, comprising:
a location determination unit for determining a geographic location of a mobile asset having an engine that produces one or more emissions during use;
a memory for storing a plurality of predetermined characteristic profiles, the characteristic profiles including information regarding geographic location and at least one of engine emission levels, noise emission levels, fuel usage levels, power output, load manifest, or speed level;
a processor in communication with the memory for accessing the characteristic profile for the determined location of the mobile asset and generating a control command responsive to a selected characteristic profile; and
a control unit on board the mobile asset controlling an operation of the mobile asset responsive to the control command.

2. The system as defined in claim 1, further comprising:
a monitor unit monitoring values of an emission parameter of the mobile asset indicative of the emissions produced by the engine; and
memory storing the values of the emission parameter of the mobile asset and at least one of the time and the location of the mobile asset when the engine emission was monitored.

3. The system as defined in claim 2, further comprising:
a communications interface for transmitting the values of the emission parameter off-board the mobile asset; and
a monitoring system, remote from the mobile asset, for receiving the values of the emission parameter transmitted via the communications interface.

4. The system as defined in claim 3, wherein the monitor unit comprises a sensor selected from the group consisting of an engine inlet air temperature sensor, a fuel injection timing sensor, a fuel injection pressure sensor, and a sensor sensing engine exhaust characteristics.

5. The system as defined in claim 3, wherein the monitor unit comprises at least one of an engine power sensor, an engine speed sensor, or a fuel usage sensor.

6. The system as defined in claim 1, further comprising a communication link that provides external information to the processor regarding one or more of tax liabilities for operation, weather considerations, damage risk, or proximity to population centers, and the processor generates the control command further based on the external information provided through the communication link.

7. A method of monitoring a mobile asset, comprising:
determining a location of a mobile asset;
selecting a characteristic profile of the mobile asset as a function of the mobile asset location;
controlling an operation of the mobile asset in response to a selected characteristic profile;
monitoring values of the mobile asset operation during the operation control with reference to the selected characteristic profile; and
storing the monitored values.

8. The method as defined in claim 7, further comprising providing the monitored values to a central monitoring system off-board the mobile asset.

9. The method as defined in claim 8, wherein the monitored values are emissions values, and further comprising determining compliance with a pre-determined emission profile based on the emission values.

10. The method as defined in claim 9, further comprising allocating, at the central monitoring system, one or more emission credits for emission values less than a minimum value required by the emission profile.

11. The method as defined in claim 7, wherein controlling the operation includes increasing a security level of the mobile asset based on the damage risk.

12. The method as defined in claim 7, further comprising checking the load manifest, and
if the load manifest indicates the presence of a determined material or substance then controlling the operation when the mobile asset is proximate to a population center in a first manner, and in when the mobile asset is distal from the population center in a second, different way.

13. The method as defined in claim 7, further comprising checking a weather database, comparing the results of the weather database check with the location of the mobile asset, and
if the weather database indicated the weather is of a first type, then controlling the operation in a first manner, and
if the weather database indicated the weather is of a second, different type controlling the operation in a second, different way.

14. The method as defined in claim 7, further comprising checking a tax liabilities database, comparing the results of the weather database check with the location of the mobile asset, and
if the tax liability database indicates a tax liability of a first type, then controlling the operation in a first manner, and
if the tax liability database indicates a tax liability of a second, different type controlling the operation in a second, different way.

15. A method for managing operation of a mobile asset that moves between at least two operating areas, the mobile asset having at least two emission profiles of operation, the mobile asset traveling along a path comprised of at least two operating areas, each operating area having at least one emission profile associated therewith, with the emission profile of one operating area being different from that of a second area, the method comprising:
monitoring a location of the mobile asset to determine its operating area;
controlling an operation of the mobile asset as a function of the determined operation area and an associated emission profile, the emissions profile including a restriction on an operation of the mobile asset based on its position relative to an emission control area; and
storing values of an emission parameter of the mobile asset associated with operation of the mobile asset in the operating area.

16. The method as defined in claim 15, further comprising:
storing the values of the emission parameter on-board the mobile asset; and
periodically downloading the stored emission values.

17. The method as defined in claim 15, further comprising calculating a rate of engine emission discharge.

18. The method as defined in claim 15, further comprising calculating an amount of an engine emission discharge during a time the mobile asset is located in a predetermined geographic area.

19. The method as defined in claim 15, wherein the mobile asset is one of a fleet of similar mobile assets, the method further comprising calculating an amount of engine emission discharge for each of the mobile assets of the fleet located in a predetermined area during a selected interval of time.

20. The method as defined in claim 13, further comprising controlling the operation of each of the mobile assets entering, leaving, and operating in a predetermined operating area so that an amount of engine emission discharge from each of the mobile assets does not exceed a predetermined limit.
